(19) United States
(12) Patent Application Publication
(10) Pub. No.: US 2019/0299430 A1
(43) Pub. Date: Oct. 3, 2019

(54) BUTTON LOCK MECHANISM FOR FOLDING KNIVES

(71) Applicant: Allen Elishewitz, New Braunfels, TX (US)

(72) Inventor: Allen Elishewitz, New Braunfels, TX (US)

(21) Appl. No.: 15/940,763

(22) Filed: Mar. 29, 2018

(51) Int. Cl. B26B 1/04

(52) U.S. Cl. CPC B26B 1/046

(57) ABSTRACT

A locking folding knife includes a handle; a blade pivotally coupled to the handle, and moveable between a closed position and an open position; and a locking device movable between a locked position and an unlocked position along an axis generally perpendicular to a plane defined by the blade. A tang of the blade has a substantially planar locking surface, and the locking device has a corresponding substantially planar blade engagement surface. The locking device secures the blade in the open position when the locking device is in the locked position, the substantially planar blade engagement surface being abutted with the substantially planar locking surface. The locking also comprises an offset post providing the additional advantage of design flexibility.

### FIELD OF THE INVENTION

The present invention relates to knives. More particularly, the invention relates to an improved button lock mechanism for use with folding type knives, which mechanism is particularly adapted to provide increased load bearing capacity while simultaneously facilitating flexibility of design.

### BACKGROUND OF THE INVENTION

The traditional button lock mechanism for securing the open blade of a folding knife has long been regarded for its ability to produce a knife with strong locking strength. As shown, for example, in U.S. patent application Pub. No. 2013/0125403 A1 published May 23, 2013 and in U.S. patent application Pub. No. 2017/0232622 A1 published Aug. 17, 2017, each of which is by this reference incorporated herein as though now set forth in its respective entirety, the industry standard implementation of the button lock (also referred to as a plunge lock) generally comprises a dumbbell-shaped piston adapted to engage a tang portion of a knife blade. As shown and described in the foregoing references, the traditional piston includes a cylindrical head, which protrudes as a button from a first side of a knife handle. A cylindrical cup is axially aligned with the cylindrical head, and connected therewith by an also axially aligned post running between the cylindrical head and the cylindrical cup, which is received within a recess formed on the inside of a second side of the knife handle. A spring, housed within the cup adjacent the inside wall of the recess, provides locking force to the piston.

While this traditional implementation, properly executed, can produce a strong locking mechanism compared to other mechanisms, it can be difficult and expensive to manufacture correctly. On one hand, it is necessary to provide sufficient bevel, or taper, on the inside edge of the cylindrical cup to keep the piston from becoming inadvertently dislodged from the tang of the blade during use of the knife. On the other hand, however, in the traditional cylindrical implementation, increased bevel will result in less available load bearing surface. As a result of the overriding need to balance the functional requirements of the traditional button lock, implementation from one knife design to another is generally very standardized such that flexibility of design most always gives way to functional rigors.

Additionally, Applicant has observed numerous other deficiencies of the traditionally implemented button lock. For example, the cylindrical shape of the mechanism is subject to rolling during use, which creates uneven wear patterns. Likewise, the cylindrical piston is subject to tilting or rocking, which can result in unintended disengagement of the locking mechanism.

Still further, even though the traditional implementation is comparatively strong with respect to the prior art, it nonetheless has weak points. For example, the post, which must be centrally located on the axis of the piston, is necessarily limited in size in order to provide clearance for the tang of the knife blade when the locking mechanism is disengaged. Similarly, the circular engagement area between the edge of the cup and the tang of the blade is limited by the radius of the cup, which in turn is limited to a fraction of the height of the handle.

With the deficiencies of the prior art clearly in mind, it is an overriding object of the present invention to improve over the prior art by turning away from the traditional implementation in favor of a button lock mechanism having a substantially planar blade engagement surface.

It is a further object of the present invention to provide such an improved button lock mechanism that also readily and reliably produces increased load bearing capacity.

Additionally, it is an object of the present invention to provide such an improved button lock mechanism that is stable is operation, thereby producing a consistent engagement with the blade.

It is also an object of the present invention to provide such an improved button lock mechanism that is amenable to increased mass, thereby producing a locking mechanism of far greater strength than is available in the prior art.

It is a further object still of the present invention to provide such an improved button lock mechanism that is also readily amenable to flexibility of design, thereby broadening the scope of designs incorporating the structural benefits of the button lock mechanism.

### SUMMARY OF THE INVENTION

In accordance with the foregoing objects, the present invention—a locking folding knife—generally comprises a handle; a blade pivotally coupled to the handle, and moveable between a closed position and an open position, and a locking device movable between a locked position and an unlocked position along an axis generally perpendicular to a plane defined by the blade. A tang of the blade comprises a substantially planar locking surface, and the locking device comprises a corresponding substantially planar blade engagement surface. The locking device secures the blade in the open position when the locking device is in the locked position, the substantially planar blade engagement surface being abutted with the substantially planar locking surface.

The locking also comprises an offset post providing the additional advantage of design flexibility.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1 shows, in an isometric view, a button lock folding knife incorporating a preferred implementation of the lock mechanism of the present invention, the knife being shown with blade fully folded;

FIG. 2 shows, in an isometric view generally corresponding to the view of FIG. 1, the button lock folding knife of FIG. 1 with blade fully extended;

FIG. 3 shows, in an exploded view, various details of the button lock folding knife of FIG. 1;

FIG. 4 shows, in a partially cut away side view, various additional details of the button lock folding knife of FIG. 1 depicted with the second side of the knife handle omitted for clarity;

FIG. 5 shows, in a top plan view, the button lock folding knife of FIG. 1;

FIG. 6 shows, in a cross sectional view taken though cut line 6-6 of FIG. 5, various details of the relative positioning of the button of the present invention with respect to the tang of the knife's fully folded blade;

FIG. 7 shows, in a partially cut away side view generally corresponding to the view of FIG. 4, various additional details of the button lock folding knife of FIG. 2 depicted with the second side of the knife handle omitted for clarity;

FIG. 8 shows, in a top plan view, the button lock folding knife of FIG. 2;

FIG. 9 shows, in a cross sectional view taken though cut line 9-9 of FIG. 8, various details of the relative positioning of the button of the present invention with respect to the tang of the knife's fully extended blade;

FIG. 10 shows, in a partially cut away detail view of the tang of the blade of the button lock folding knife, various details of the most preferred implementation of the locking surface of the blade;

FIG. 11 shows, in an isometric view, various details of the preferred implementation of the substantially rectilinear button of the lock mechanism of the present invention;

FIG. 12 shows, in an elevational view, details of the most preferred implementation of the blade engagement surface of the button of FIG. 11; and

FIG. 13 shows, in a bottom plan view, still further details of the most preferred implementation of the blade engagement surface of the button of FIG. 11.

### DETAILED DESCRIPTION OF THE PREFERRED EMBODIMENT

Although those of ordinary skill in the art will readily recognize many alternative embodiments, especially in light of the illustrations provided herein, this detailed description is exemplary of the preferred embodiment of the present invention, the scope of which is limited only by the claims appended hereto.

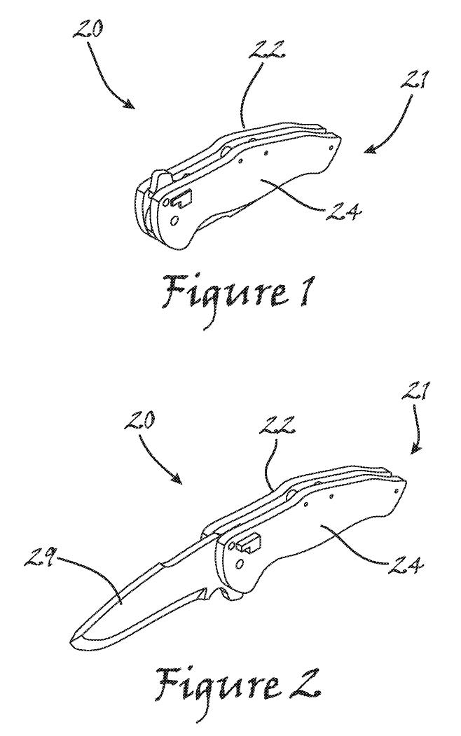

Referring now to the figures generally, and to FIGS. 1 through 3 in particular, a preferred implementation of the folding knife 20 of the present invention is shown to include a handle 21 having a first end pivotally coupled to a blade 29. As shown in the figures, the blade 29 is coupled to the handle 21 by a blade pivot pin 28, or substantially equivalent axle, that extends through a pivot hole 31 through a tang 30 of the blade 29.

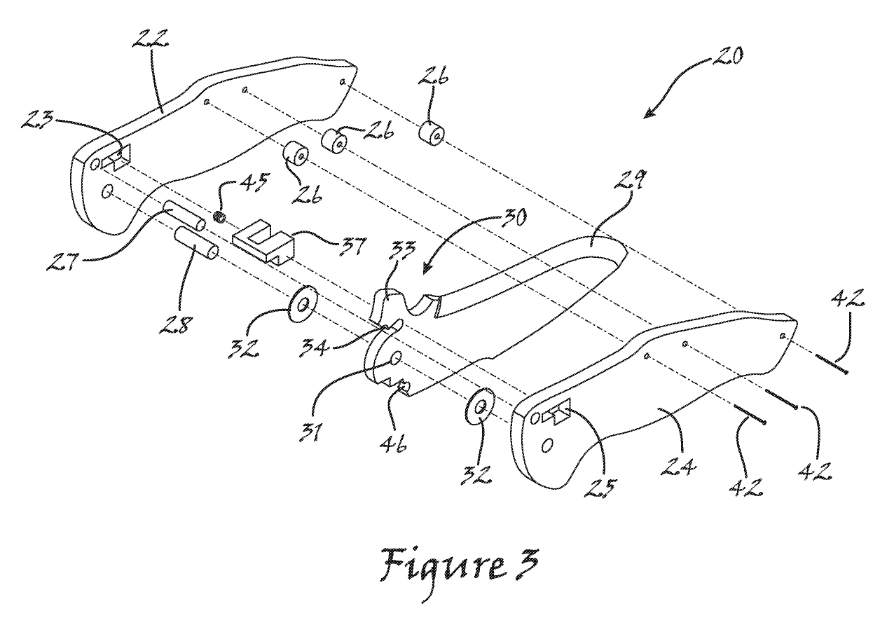

According to the exemplary embodiment shown, the handle 21 of the folding knife 20 includes a pair of handle sides shown as a first handle side 22 and a second handle side 24. Fasteners, such as the depicted screws 42, are used to couple the handle sides 22, 24 together. As particularly shown in FIG. 3, however, the first handle side 22 and the second handle side 24 are spaced apart by a plurality of otherwise conventional stand-offs 26, thereby providing space between the handles for receiving the blade 29. In order to provide operational spacing between the sides of the blade 29 and the interior sides of the handle 21, washers 32 or the like may be provided, as is otherwise conventional in the art.

The blade 29 may be fully folded into the handle 21, as shown in FIG. 1, or fully extended, as shown in FIG. 2. A stop pin 27 is disposed between the first handle side 22 and the second handle side 24, and the tang of the handle is provided with a pair of stops 34, 46. The stops 34, 46 are provided and positioned radially about the pivot hole 31 through the tang 30 such that the one stop 34 engages the stop pin 27 when the blade 29 is fully folded into the handle 21 and the opposite stop 46 engages the stop pin 27 when the blade 29 is fully extended. In this manner, the stops 34, 46 and stop pin 27 are cooperatively adapted to confine the swing of the blade 29 to the arc between fully folded and fully extended.

In a stark departure from the prior art, the locking device 43 of the knife 20 of the present invention is shown in a preferred implementation to generally comprise an L-shaped body 37. While other shapes may be implemented, as will be apparent to those of ordinary skill in the art with the benefit of this exemplary description of the present invention, it is considered a critical aspect of the present invention that the locking mechanism 43 includes a substantially planar blade engagement surface 39 positioned to operably engage a substantially planar locking surface 35 formed or otherwise provided on the tang 30 of the blade 29.

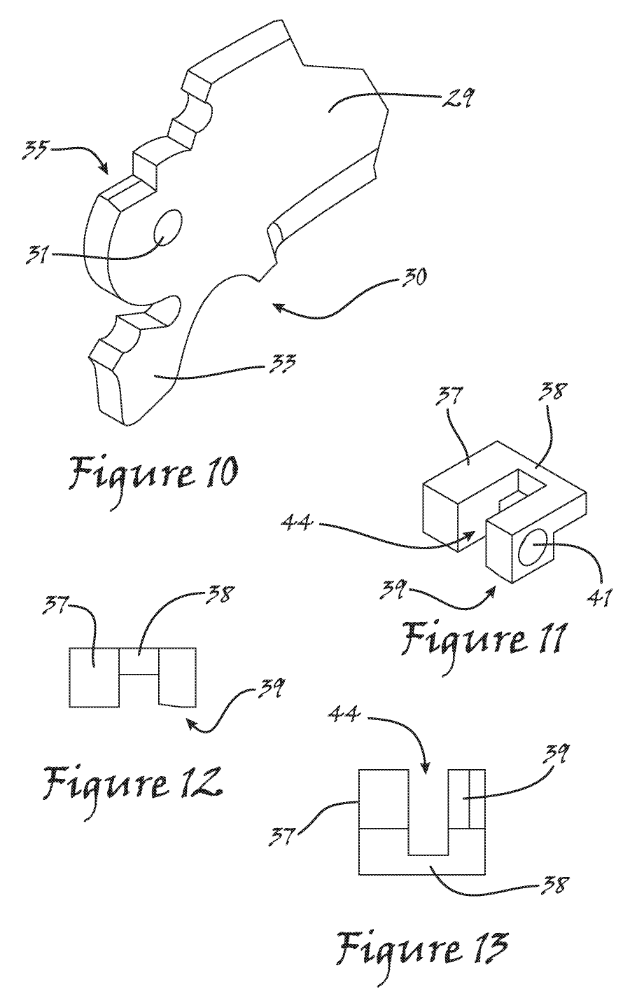

In the exemplary embodiment, a button recess 23 is provided on the inside of the first handle side 22 and a button hole 25 is provided through the second handle side 24. The button recess 23 is sized, shaped and otherwise adapted to accommodate a first side of the L-shaped body 37, which first side of the body 37 is provided with a spring cavity 41, as shown in FIG. 11. Likewise, the button hole 25 is sized, shaped and otherwise adapted to accommodate a second side of the L-shaped body 37, which second side of the body 37 may protrude through the button hole 25 for operable engagement of the user.

In an important aspect of the present invention, and made possible by turning away from the longstanding teaching of cylindrical mechanisms, the locking device 43 of the present invention is shown to also include a highly offset post 38 interconnecting the first and second L-shaped sides of the body 37. Because the present invention contemplates the ability to offset the post 38, as particularly shown in FIGS. 11 through 13, a central slot 44, substantially aligned with the tang 30 of the blade 29, may be provided through the body 37.

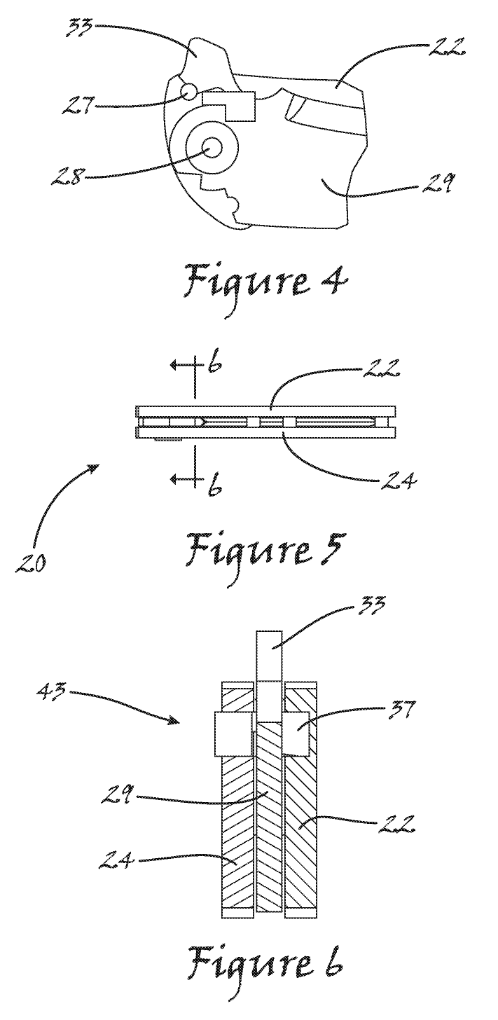

As shown in FIGS. 4 through 6, when the blade 29 of the knife 20 is in its fully folded configuration, the body 37 is generally retracted into the button recess 23 in the first handle side 22. Because the post 38 of the body 37 is offset, however, components of the tang 30 of the blade, such as, for example, the flipper 33 may pass through central slot 44 of the body 37, as shown in FIG. 4. As a result, a knife maker is more free to implement creative designs, such as placing of the stop pin 27 in a position to be engaged by a stop 34 provided on the flipper 33.

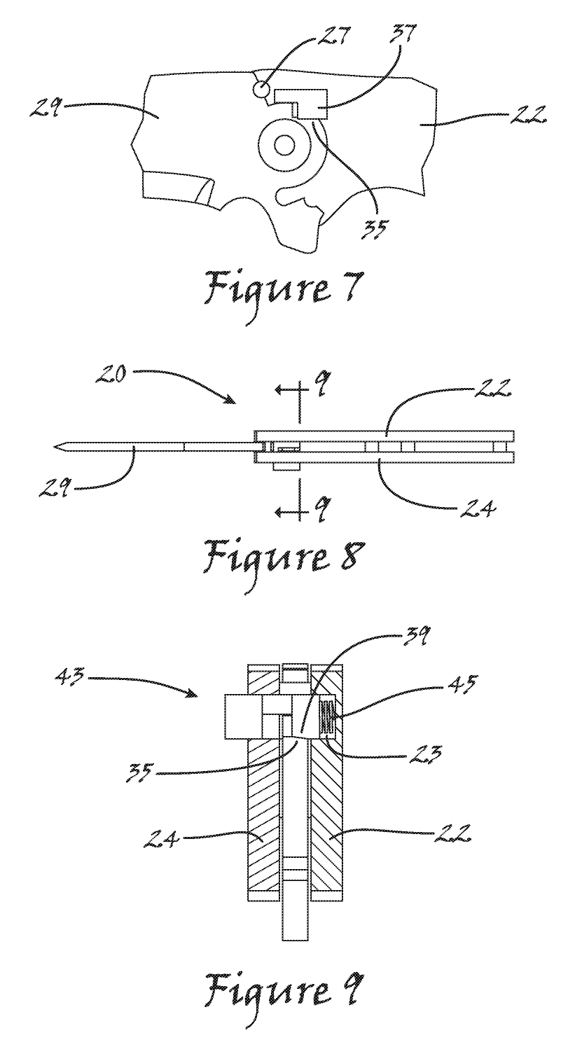

As shown in FIGS. 7 through 10, when the blade 29 of the knife 20 is in its fully extended configuration, the body 37 is thrust out of the button recess 23 by a spring contained within a provided spring cavity 41. As shown in the figures, and in FIG. 10 in particular, the tang 30 of the blade 29 is provided with a substantially planar locking surface 35 for engaging with the blade engagement surface 39 of the button 37. In order to prevent dislodging of the body 37 from the knife 20, however, the substantially planar locking surface 35 of the blade 29 includes a beveled portion corresponding to a beveled portion provided in the substantially planar blade engagement surface 39 of the body 37 of the locking mechanism 43, as shown in FIGS. 10 through 13.

In implementing the present invention, it is noted that some attention must be given to the angle of the provided beveled portions forming surfaces 35, 39. If the angle is too shallow, the body 37 may slip off the tang 30 and escape through the button hole 25. On the other hand, if the angle is too great the body 37 may slip off the tang 30 and back into the button recess 23, thereby inadvertently releasing the blade 29. As guidance, Applicant has found that angle of about 5 degrees to about 8 degrees is generally suitable for the implementation as depicted in the figures.

In use, a user of the knife 20 of the present invention simply extends the blade 29 from the configuration of FIG. 1 to that of FIG. 2, at which point the body 37 will, under the force of the spring 45, take the position as shown in FIG. 9. When ready to stow the blade, the user will push the body 37 inward through the button hole 25, and while holding the body 37 in the position as generally depicted in FIG. 6, the user will fold the blade 29 in toward the configuration of FIG. 1. As will be apparent to those of ordinary skill in the art, in light of this exemplary description, the blade 29 need only rotate slightly about the pivot 28 before the user may stop applying pressure.

As described, the knife 20 implemented according to the present invention improves over the prior art in numerous ways, including:
the ability to provide a taper on the tang of the blade that travels the complete length of the blade engaging portion of the locking mechanism without decreasing the load bearing capacity of the locking mechanism;
the ability to provide greater surface contact between the blade and the blade engaging portion of the locking mechanism;
the ability to ensure even component wear;
greater flexibility of design;
better engagement of the locking members; and
the ability to provide more massive, and therefore stronger, components.

While the foregoing description is exemplary of the preferred embodiment of the present invention, those of ordinary skill in the relevant arts will recognize the many variations, alterations, modifications, substitutions and the like as are readily possible, especially in light of this description, the accompanying drawings and claims drawn thereto. In any case, because the scope of the present invention is much broader than any particular embodiment, the foregoing detailed description should not be construed as a limitation of the scope of the present invention, which is limited only by the claims appended hereto.

What is claimed is:

1. A locking folding knife, said locking folding knife comprising:
a handle;
a blade pivotally coupled to said handle, said blade being moveable between a closed position and an open position, and;
a locking device movable between a locked position and an unlocked position along an axis generally perpendicular to a plane defined by the blade; and
wherein:
a tang of said blade comprises a substantially planar locking surface;
said locking device comprises a substantially planar blade engagement surface;
said locking device secures said blade in said open position when said locking device is in said locked position, wherein said substantially planar blade engagement surface abuts said substantially planar locking surface.

2. The locking folding knife as recited in claim 1, wherein:
said substantially planar blade engagement surface comprises a first beveled portion; and
said substantially planar locking surface comprises a second beveled surface, said second beveled surface corresponding to said first beveled surface.

3. The locking folding knife as recited in claim 2, wherein each said beveled surface is provided at an angle between about 5 degrees and about 8 degrees.

4. The locking folding knife as recited in claim 3, wherein each said beveled surface is provided at an angle of about 8 degrees.

5. The locking folding knife as recited in claim 1, wherein said locking device comprises an offset post.
